(19) United States
(12) Patent Application Publication
(10) Pub. No.: US 2007/0285437 A1
(43) Pub. Date: Dec. 13, 2007

(54) SYSTEM FOR AND METHOD OF MANAGING IMAGE DATA

(75) Inventor: Akio ISHIKAWA, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/759,993

(22) Filed: Jun. 8, 2007

(30) Foreign Application Priority Data
Jun. 13, 2006 (JP) 2006-163447

(51) Int. Cl. G09G 5/00

(52) U.S. Cl. 345/625

(57) ABSTRACT

Drawings in a desired range of pages are selected from drawings which make up a completion report retrieved by a completion report retrieving means. A tag data setting means sets tag data for the selected drawings. The tag data is stored as data related to the drawings in a tag data storing means. Desired drawings are retrieved according to the tag data.

### BACKGROUND OF THE INVENTION

1. Field of the Invention

The present invention relates to a system for and a method of managing image data to allow desired image data to be efficiently selected from stored image data representing a plurality of pages of drawings or documents.

2. Description of the Related Art

There has heretofore been developed a system for reading a number of design drawings, specifications, or the like with a scanner, storing them as digital data in a large-capacity recording medium such as a hard disk, a CD-ROM, a DVD, or the like, setting retrieval conditions when necessary, retrieving a desired drawing or the like, and displaying or printing the retrieved drawing or the like.

For acquiring a plurality of design drawings, for example, if a process of setting retrieving conditions for each of the design drawings that need to be retrieved, and retrieving and printing the design drawing is repeated, then not only a wait time for printing each of the design drawings is wasteful, but also the user's thought is interrupted each time a design drawing is printed. Therefore, the entire process is inefficient.

According to one conventional solution, any optional image data or character string data among a plurality of documents having a plurality of pages of image data is registered as a bookmark, and a pointer representing any optional page of an optional document related to the bookmark is registered. Images of the pages of the documents can simultaneously be retrieved by specifying the bookmark (see Japanese Laid-Open Patent Publication No. 6-243172).

However, the conventional approach is disadvantageous in that if the number of data that need to be retrieved increases, then correspondingly more bookmarks have to be registered and hence it is highly cumbersome to manage the bookmarks. Furthermore, since image data themselves are used as bookmark information, if there are many identical image data, then it may be impossible to retrieve appropriate image data.

### SUMMARY OF THE INVENTION

It is a general object of the present invention to provide a system for and a method of managing image data to allow desired image data to be easily and efficiently retrieved from a plurality of pages of drawings or documents that are stored as image data.

A major object of the present invention is to provide a system for and a method of managing image data to allow desired image to be retrieved by setting tag data therefor.

Another object of the present invention is to provide a system for and a method of managing image data to allow overlapping image data to be retrieved by setting a plurality of different tag data therefor.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a drawing management system according to an embodiment of the present invention;

FIG. 2 is a functional block diagram of major units of the drawing management system according to the embodiment;

FIG. 3 is a flowchart of a drawing booking process, a drawing registering process, and a drawing saving process;

FIG. 4 is a flowchart of a drawing retrieving process;

FIG. 5 is a view showing a menu screen displayed on the display monitor of a drawing retrieving unit;

FIG. 6 is a view showing a drawing number booking screen displayed on the display monitor of the drawing retrieving unit;

FIG. 7 is a view showing a drawing attribute data registering screen displayed on the display monitor of the drawing retrieving unit;

FIG. 8 is a view showing a new registration screen displayed on the display monitor of the drawing retrieving unit;

FIG. 9 is a view showing a registration request slip generated by the drawing retrieving unit;

FIG. 10 is a view showing a drawing;

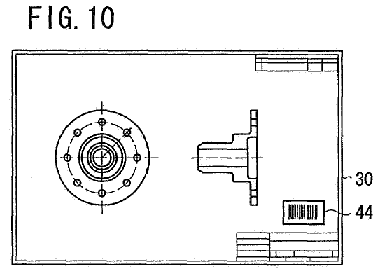

FIG. 11 is a view showing a bundle of drawing sheets;

FIG. 12 is a view showing a retrieval condition input screen displayed on the display monitor of the drawing retrieving unit;

FIG. 13 is a view showing a drawing retrieval result screen displayed on the display monitor of the drawing retrieving unit;

FIG. 14 is a view showing a drawing retrieval result screen including a compressed image displayed on the display monitor of the drawing retrieving unit;

FIG. 15 is a diagram showing the manner in which the compressed image shown in FIG. 14 is scrolled;

FIG. 16 is a view showing a drawing retrieval result screen including an actual drawing displayed on the display monitor of the drawing retrieving unit;

FIG. 17 is a flowchart of a process of setting tag data for a desired drawing;

FIG. 18 is a flowchart of a process of retrieving a desired drawing using the set tag data;

FIG. 19 is a view showing a retrieval condition input screen for a completion report displayed on the display monitor of the drawing retrieving unit;

FIG. 20 is a view showing a completion report list display screen displayed on the display monitor of the drawing retrieving unit;

FIG. 21 is a view showing a completion report display screen displayed on the display monitor of the drawing retrieving unit;

FIG. 22 is a view showing a tag setting screen displayed in the completion report display screen shown in FIG. 21; and

FIG. 23 is a view showing drawings with tag data set therefor, selected from a completion report.

### DESCRIPTION OF THE PREFERRED EMBODIMENT

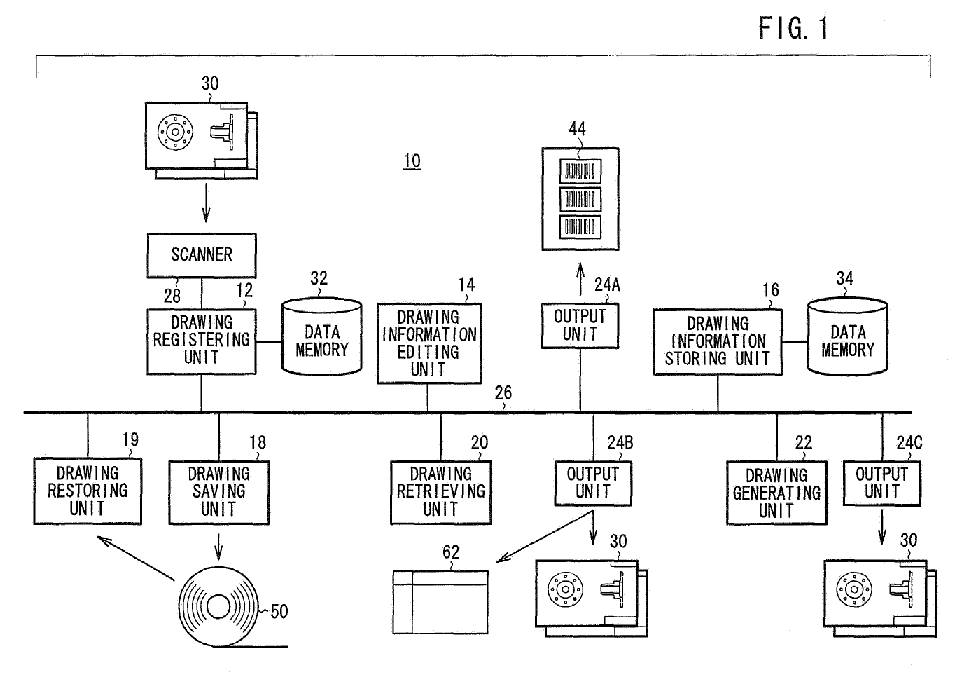

FIG. 1 shows in block form a drawing management system 10 to which a system for and a method of managing image data according to an embodiment of the present invention are applied.

As shown in FIG. 1, the drawing management system 10 comprises a drawing registering unit 12, a drawing information editing unit 14, a drawing information storing unit 16, a drawing saving unit 18, a drawing restoring unit 19, a drawing retrieving unit 20, a drawing generating unit 22, and output units 24A through 24C which are all connected to each other by a network 26.

The drawing registering unit 12 reads a drawing 30 with a scanner 28 connected thereto, and registers the read data as actual drawing image data Dorg, which is not subjected to a compression process such as a decimating process or the like, in a data storage unit (data memory) 32. The data storage unit 32 registers therein the actual drawing image data Dorg and also drawing attribute data Datt edited by the drawing information editing unit 14 in association with the actual drawing image data Dorg.

The drawing 30 includes not only a paper drawing of a machine, a facility, a circuit, or the like, but also a document image of every type of paper document such as an inspection document, a calculation document, an estimation document, a photograph or the like about a facility construction. The drawing attribute data Datt, which will be described in detail below, is data representative of an ID number and a drawing title of the drawing 30, department information as to a department, a line, etc. corresponding to the drawing 30, a generation date of the drawing 30, the name of a person in charge of the drawing 30, etc.

The drawing information editing unit 14 controls the drawing registering unit 12 to register and edit the drawing 30, and also controls the drawing information storing unit 16 to store various data including the actual drawing image data Dorg and the drawing attribute data Datt in a data storage unit (data memory) 34 that is connected to the drawing information storing unit 16.

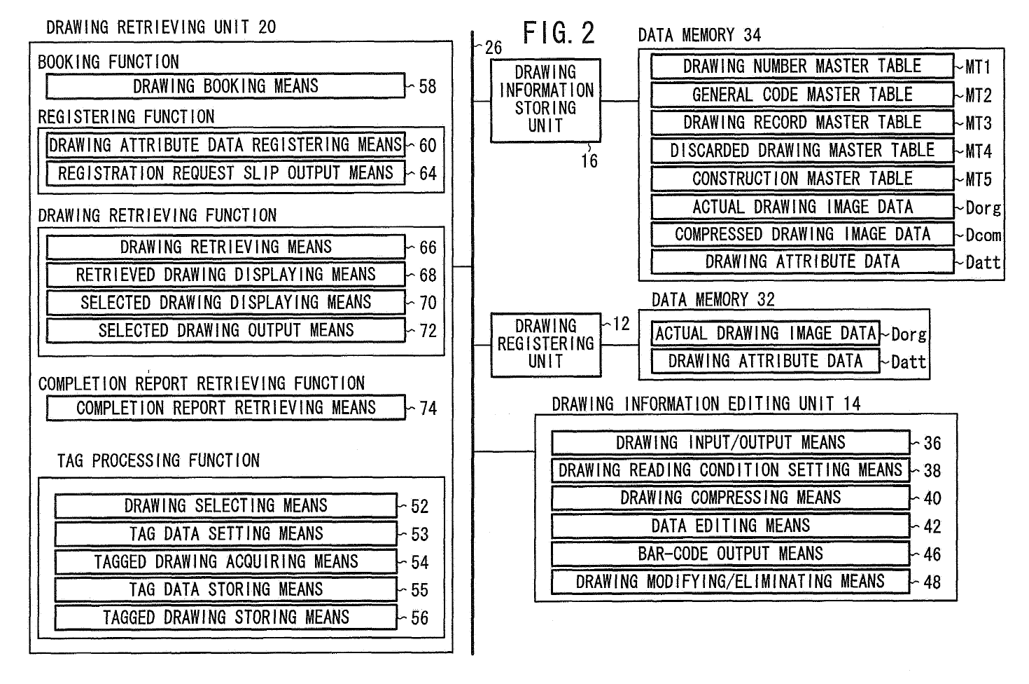

As shown in FIG. 2, the drawing information editing unit 14 comprises a drawing input/output means 36 for inputting and outputting the actual drawing image data Dorg and the drawing attribute data Datt into and from the data storage unit 32 that is connected to the drawing registering unit 12, a drawing reading condition setting means 38 for setting general drawing reading conditions of the scanner 28 such as a resolution, a reading size, a reading direction, etc. for reading a drawing 30, a drawing compressing means 40 for compressing, e.g., decimating, the actual drawing image data Dorg of the read drawing 30, to generate compressed drawing image data Dcom, a data editing means 42 for editing various data, a bar-code output means 46 for printing a bar code 44 (see FIG. 1) with an ID number identifying each drawing 30 with the output unit 24A, and a drawing modifying/eliminating means 48 for modifying and eliminating drawings 30 that have already been registered.

Data that are to be edited by the data editing means 42 include actual drawing image data Dorg, compressed drawing image data Dcom, drawing attribute data Datt, a drawing number master table MT1, a general code master table MT2, a drawing record master table MT3, a discarded drawing master table MT4, and a construction master table MT5. These data are stored in the data storage unit 34 that is connected to the drawing information storing unit 16.

The drawing number master table MT1 is a management table for setting drawing numbers for drawings 30 without overlaps, and stores drawing booking data including drawing numbers prior to the registration of drawings. The general code master table MT2 is a management table for keywords that are used to set and retrieve drawing attribute data Datt, and stores, as keywords, the type of a drawing 30 to be registered, the name of a person in charge of the drawing 30, and the information of a department corresponding to the drawing 30. The drawing record master table MT3 stores information of old drawings 30 that are produced as a result of the revision of drawings 30. The discarded drawing master table MT4 stores information of discarded drawing 30. The construction master table MT5 stores information of constructions that have been made according to drawings 30.

The drawing saving unit 18 saves a visualized drawing 30 based on actual drawing image data Dorg, directly in an image format, and also saves drawing attribute data Datt related to the actual drawing image data Dorg in a restorable visualized code format, in a microfilm 50 through a CD-ROM or the like.

The drawing restoring unit 19 restores drawing attribute data Datt and actual drawing image data Dorg from the information recorded on the microfilm 50.

The drawing retrieving unit 20 is a computer assigned to each operator who is desirous of registering drawings 30. The drawing retrieving unit 20 has a booking function for booking the registration of a drawing 30, a registering function for registering drawing attribute data Datt based on drawing booking data and generating a registration request slip, a drawing retrieving function for retrieving a desired drawing 30, a completion report retrieving function for retrieving a completion report which is a construction report that comprises a plurality of registered drawings 30, and a tag processing function for setting tag data in relation to a desired drawing 30 selected from a plurality of registered drawings 30 and acquiring a drawing 30 for which tag data has been set.

The booking function has a drawing booking means 58 for booking in advance the drawing number of a drawing 30 to be registered without overlaps, using the drawing number master table MT1 stored in the data storage unit 34.

The registering function has a drawing attribute data registering means 60 for registering drawing attribute data Datt of the drawing 30 for a drawing number registered by the drawing booking means 58, and a registration request slip output means 64 for outputting a registration request slip 62 (see FIG. 1) from the output unit 24B based on the registered drawing attribute data Datt. The registration request slip 62 is provided, together with the drawing 30 to be registered, to the operator of the drawing information editing unit 14 to ask for a registering process.

The drawing retrieving function has a drawing retrieving means 66 for setting a desired drawing retrieving condition and retrieving a drawing 30 having drawing attribute data Datt that matches the drawing retrieving condition, a retrieved drawing displaying means 68 for generating the retrieved drawing 30 from compressed drawing image data Dcom and displaying the drawing 30 together with the drawing attribute data Datt, a selected drawing displaying means 70 for displaying the compressed drawing 30 displayed by the retrieved drawing displaying means 68 as an uncompressed drawing 30 using actual drawing image data Dorg, and a selected drawing output means 72 for outputting the drawing 30 displayed by the selected drawing displaying means 70 from the output unit 24B.

The completion report retrieving function has a completion report retrieving means 74 for setting a desired construction retrieval condition and retrieving a completion report having drawing attribute data Datt that matches the construction retrieval condition. The retrieved completion report may be output from the output unit 24B.

The tag processing function has a drawing selecting means 52 (image data selecting means) for selecting a desired drawing 30 from the data storage unit 34 (image data storing means) based on an operation by the operator who uses the drawing retrieving unit 20, a tag data setting means 53 for setting tag data in relation to a selected drawing 30, a tagged drawing acquiring means 54 (image data acquiring means) for acquiring a drawing 30 specified by tag data from the data storage unit 34, a tag data storing means 55 for storing tag data with a tag name assigned thereto, and a tagged drawing storing means 56 (tagged image data storing means) for storing a drawing 30 acquired by the tagged drawing acquiring means 54, as tagged image data.

The drawing generating unit 22 comprises a CAD (Computer-Aided Design) device for generating CAD data. CAD data generated by the drawing generating unit 22 is edited and converted into actual drawing image data Dorg by the drawing information editing unit 14. Drawing attribute data Datt of the CAD data can be registered by the drawing retrieving unit 20.

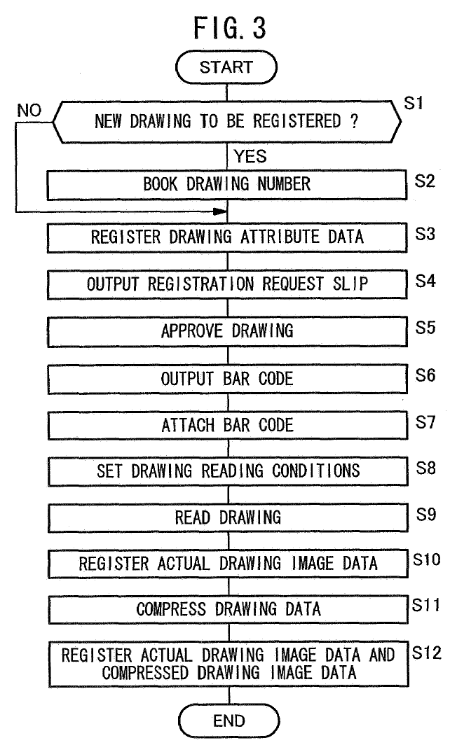

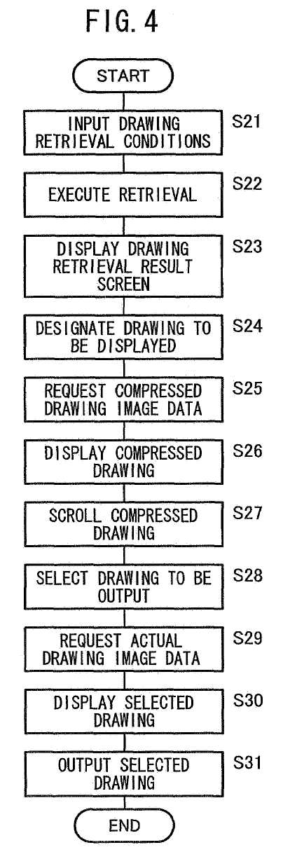

The drawing management system 10 according to the present embodiment is basically constructed as described above. Processes of registering and saving a drawing 30 using the drawing management system 10 will be described below with reference to flowcharts show in FIGS. 3 and 4.

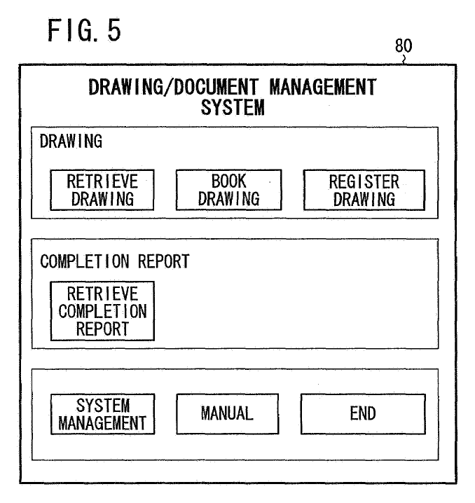

When the drawing management system 10 is activated, the display monitor thereof on each operator's desk displays a menu screen 80 shown in FIG. 5.

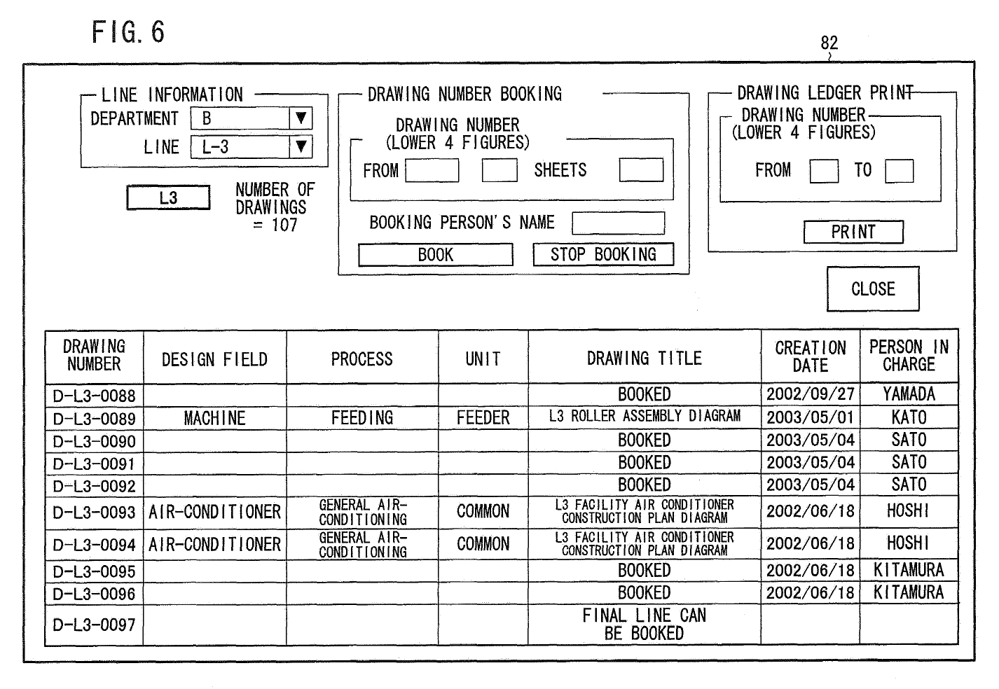

For registering a new drawing 30 in step S1, the operator selects a “BOOK DRAWING” button in the menu screen 80. When the “BOOK DRAWING” button is selected, a drawing number booking screen 82 shown in FIG. 6 is displayed on the display monitor. The operator books the drawing number using the drawing number booking screen 82 in step S2.

When the operator enters information of the department involving the facility and the production line relative to the drawing 30 based on the information set in the general code master table MT2, the drawing booking means 58 displays booked information of drawing numbers in the department B and the line L3, for example, using the drawing number master table MT1 and the drawing attribute data Datt that are stored in the data storage unit 34.

A drawing number D-L3-0088, for example, that has already been booked by another operator is displayed as “BOOKED” in the column of drawing titles. Therefore, the operator cannot use this drawing number. Another drawing number D-L3-0089, for example, is also a drawing number whose drawing 30 has already been registered because various items of information including a design field, a process, a unit, a drawing title, a generation data, and a person in charge are displayed in corresponding columns. Therefore, the operator selects a drawing number other than those registered drawing numbers.

The operator sets as many “serial numbers” of drawing numbers that can be booked as necessary, enters the name of the booking person, and selects a “BOOK” button, thus completing the process of booking the drawing number.

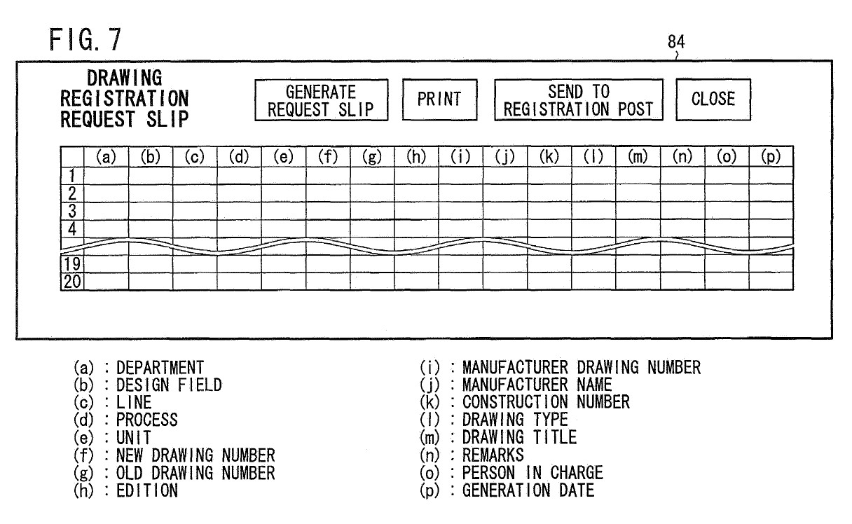

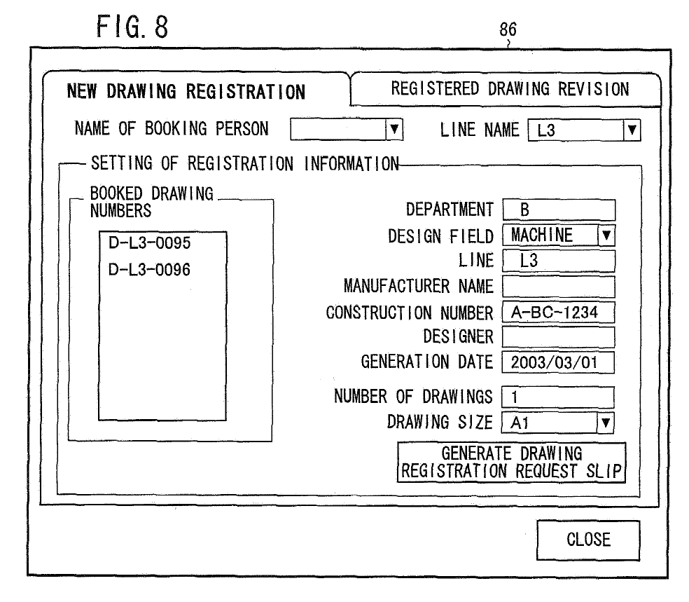

When the operator selects a “REGISTER DRAWING” button in the menu screen 80, the drawing attribute data registering means 60 displays a drawing attribute data registration screen 84 shown in FIG. 7 on the display monitor, allowing the operator to perform a registration process in step S3. When the operator selects a “GENERATE REQUEST SLIP” button in the drawing attribute data registration screen 84, a new registration screen 86 for registering a new drawing 30 shown in FIG. 8 is displayed on the display monitor. When the operator enters the name of the booking person and the line name in the new registration screen 86, if the booking process is performed in step S2, the list of drawing numbers booked in the drawing number booking screen 82 by the booking person is displayed as indicating booked drawing numbers.

The operator enters drawing attribute data Datt including the design field, the name of the manufacturer who produced the drawing 30, the construction number of the drawing 30, the designer, the generation date, the number of sheets of the drawing 30, and the drawing size, using the new registration screen 86. The operator selects, if necessary, a plurality of drawing numbers which share the entered drawing attribute data Datt. When the operator selects a “GENERATE DRAWING REGISTRATION REQUEST SLIP” button in the new registration screen 86, the drawing attribute data registration screen 84 shown in FIG. 7 which reflects the drawing attribute data Datt entered in the new registration screen 86 is displayed. The operator then enters any further necessary drawing attribute data Datt in the displayed drawing attribute data registration screen 84.

At this time, the operator enters the drawing attribute data Datt by selecting keywords registered in the general code master table MT2 of the data storage unit 34. Therefore, drawing attribute data Datt are prevented from being entered in different formats by different operators.

If the operator does not perform drawing number booking process in step S2, but is to revise an already registered drawing 30, then the operator selects a revision registration drawing tag in the new registration screen 86 shown in FIG. 8, retrieves a drawing to be revised, and performs a revision registration process. The information of the old drawing 30 prior to being revised is stored in the drawing record master table MT3.

After the operator has set the drawing attribute data Datt as described above, the operator selects a “SEND TO REGISTRATION POST” in the drawing attribute data registration screen 84 to sent the drawing booking data to the drawing information editing unit 14.

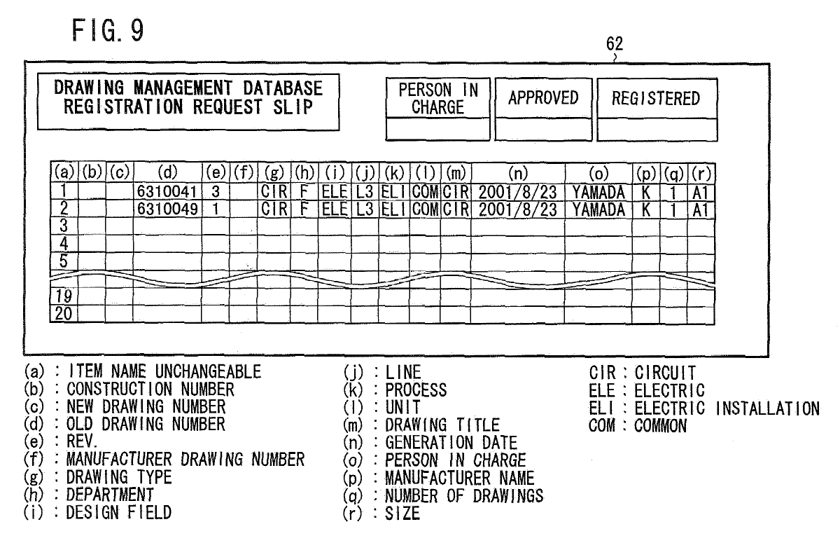

When the operator selects a “PRINT” button in the drawing attribute data registration screen 84, the registration request slip output means 64 outputs the registration request slip 62 shown in FIG. 9 from the output unit 24B in step S4.

The operator signs a “PERSON IN CHARGE” column in the registration request slip 62, and submits the registration request slip 62 as attached to the drawing 30 to be registered, to an approval person. The approval person confirms the contents of the drawing 30, and signs an “APPROVED” column in the registration request slip 62 in step S5.

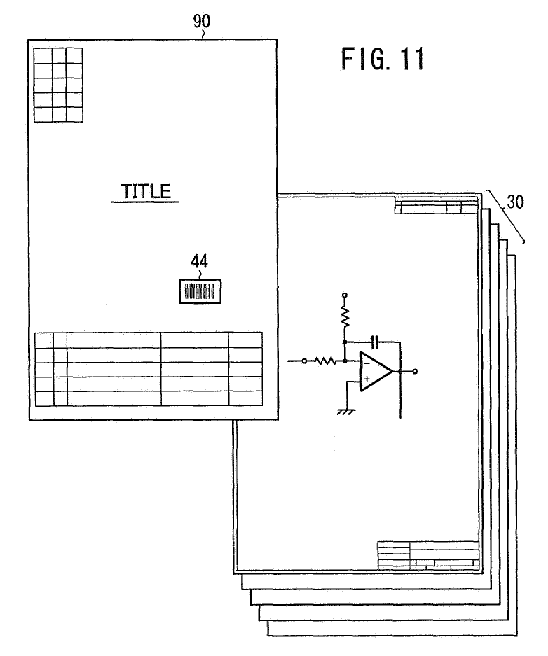

The drawing 30 that has been approved by the approval person is transferred to a drawing registrar for registration. Prior to the registration of the drawing 30, the bar-code output means 46 of the drawing information editing unit 14 outputs a bar code 44 that is provided with ID number set as the drawing attribute data Datt of the drawing 30 from the output unit 24A in step S6. The operator applies the bar code 44 to a given position on the drawing 30 in the form of single sheet in step S7. If the drawing 30 is in the form of a bundle of sheets such as circuit drawing sheets or document sheets, then, as shown in FIG. 11, a cover sheet 90 with a given title etc. provided therein is added to the bundle of sheets of the drawing 30, and the bar code 44 is applied to the cover sheet 90.

Then, the drawing registrar compares the registration request slip 62 (see FIG. 9) attached to the drawing 30 and the drawing attribute data Datt stored as the drawing booking data in the registration post with each other for confirmation, and thereafter starts the process of registering the drawing 30 with the drawing registering unit 12.

The drawing reading condition setting means 38 of the drawing information editing unit 14 displays an screen for setting drawing reading conditions such as a resolution, a reading size, a reading direction, etc. of the drawing 30 on the display monitor. The drawing registrar then sets drawing reading conditions depending on the drawing 30 to be registered according to the displayed setting screen in step S8.

When the drawing reading conditions are set, the drawing input/output means 36 of the drawing information editing unit 14 controls the drawing registering unit 12 according to the drawing reading conditions to read the drawing 30 with the scanner 28 in step S9.

The drawing 30 read by the scanner 28 is registered as actual drawing image data Dorg, which is uncompressed image data, together with related drawing attribute data Datt, in the data storage unit 32 in step S10.

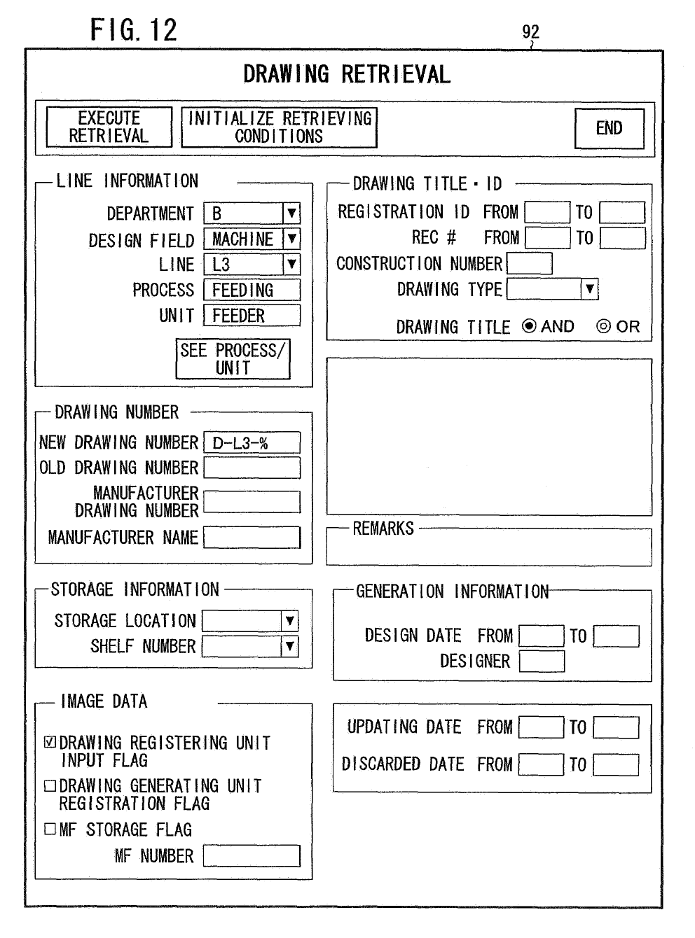

When the actual drawing image data Dorg is registered in the data storage unit 32, the drawing information editing unit 14 sets a drawing registering unit input flag (see FIG. 12) which indicates that the drawing 30 is entered into the data storage unit 32, with respect to the drawing attribute data Datt. After having registered the drawing 30, the drawing registrar signs a “REGISTERED” column in the registration request slip 62 (see FIG. 9), and returns the registration request slip 62 together with the drawing 30 to the person who has requested the drawing registration.

After the actual drawing image data Dorg is registered in the data storage unit 32, the drawing information editing unit 14 controls the drawing compressing means 40 to compress, e.g., decimates, the actual drawing image data Dorg in step S11, thereby generating compressed drawing image data Dcom. Then, the drawing input/output means 36 sends the actual drawing image data Dorg and the compressed drawing image data Dcom via the network 26 to the drawing information storing unit 16, which registers them in the data storage unit 34 in step S12.

A process of retrieving a drawing 30 thus registered will be described below.

If the operator selects a “RETRIEVE DRAWING” button in the menu screen 80 (see FIG. 5) displayed on the display monitor of the drawing retrieving unit 20, a retrieval condition input screen 92 shown in FIG. 12 is displayed on the display monitor. The operator then enters a retrieval condition for a desired drawing 30 in the retrieval condition input screen 92 in step S21. The retrieval condition may be drawing attribute data Datt of the drawing 30 stored in the data storage unit 34.

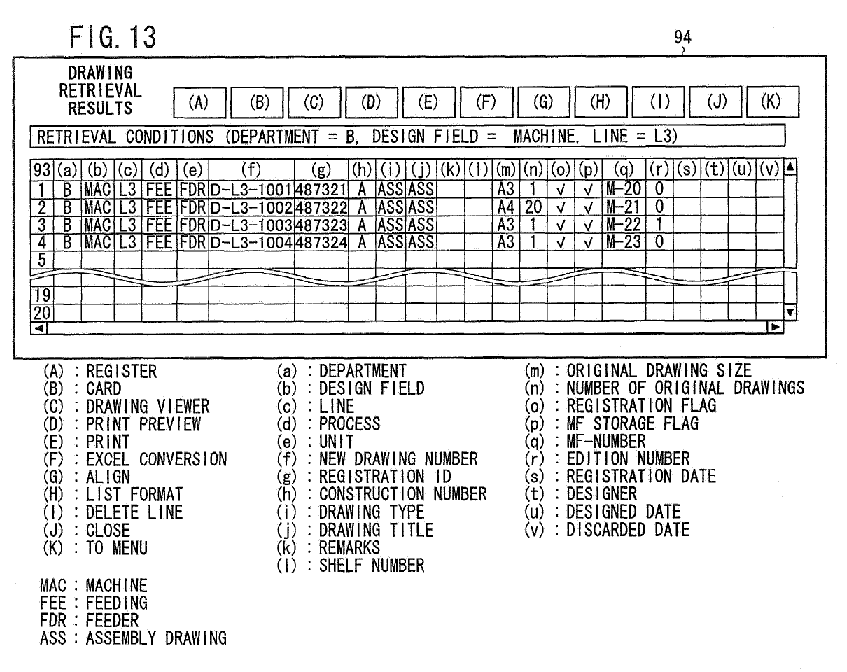

When the retrieval condition is entered and a “EXECUTE RETRIEVAL” button is selected, the drawing retrieving means 66 retrieves drawing attribute data Datt corresponding to the retrieval condition in step S22, and displays a drawing retrieval result screen 94 shown in FIG. 13 in step S23. The drawing retrieval result screen 94 displays only the drawing attribute data Datt of each drawing 30 that has been retrieved.

The operator designates desired drawing data from the drawing attribute data Datt displayed in the drawing retrieval result screen 94 in step S24. If the operator finds it difficult to narrow down the desired drawing data to one with the drawing attribute data Datt, then the operator designates a plurality of drawing data.

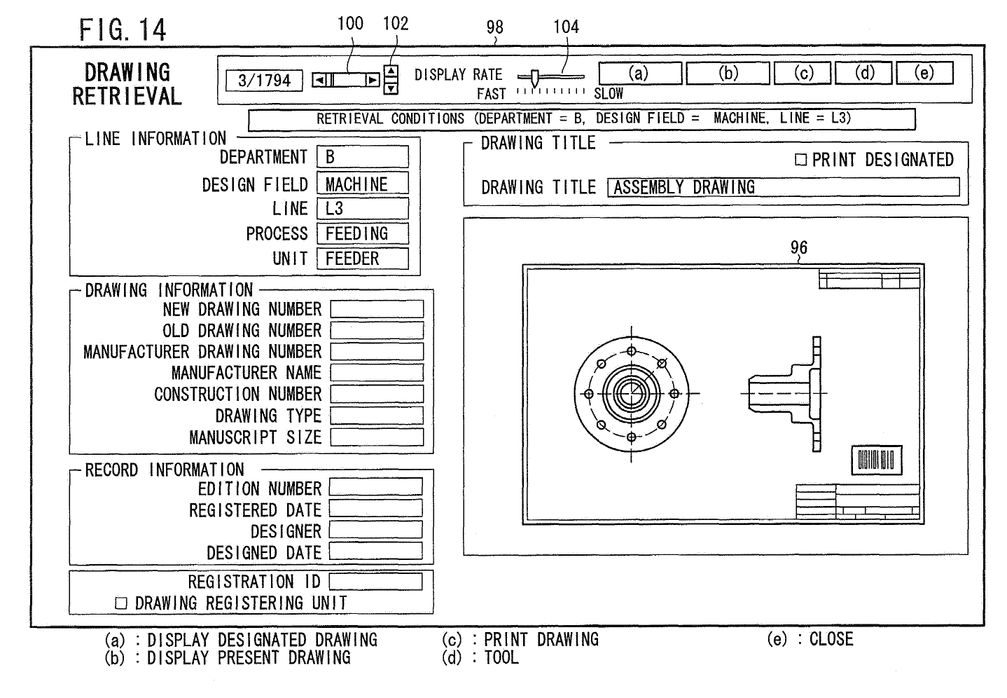

When the operator designates desired drawing data and selects a “DRAWING VIEWER” button, the retrieved drawing displaying means 68 requests the drawing information storing unit 16 to send compressed drawing image data Dcom relative to the designated drawing data in step S25. The drawing information storing unit 16 reads the requested compressed drawing image data Dcom from the data storage unit 34, and sends the compressed drawing image data Dcom to the drawing retrieving unit 20. As shown in FIG. 14, the drawing retrieving unit 20 displays a compressed drawing 96 according to the compressed drawing image data Dcom that have been sent, together with its drawing attribute data Datt, as a drawing retrieval result screen 98 in step S26.

Since the compressed drawing 96 displayed in the drawing retrieval result screen 98 is based on the compressed drawing image data Dcom transmitted from the data storage unit 34 which is much smaller in amount than the actual drawing image data Dorg, the compressed drawing 96 can be displayed in a very short period of time. As the drawing retrieval result screen 98 includes the drawing title as the drawing attribute data Datt, the operator can grasp the drawing contents from the displayed drawing title even if the details of the displayed compressed drawing 96 cannot be determined.

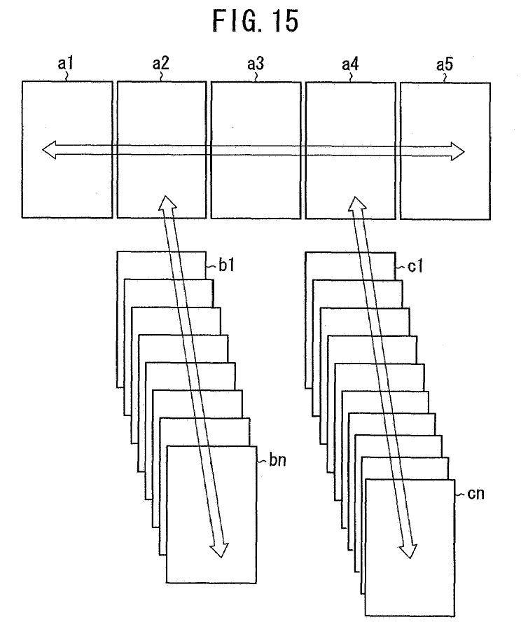

The drawing retrieval result screen 98 also includes a horizontal scroll bar 100 and a vertical scroll bar 102. If a plurality of drawing data are selected in the drawing retrieval result screen 94 shown in FIG. 13, then the operator operates the horizontal scroll bar 100 to scroll through and display the drawing attribute data Datt and the compressed drawings 96 relative to the drawing data, successively in the order of drawing data designated in the drawing retrieval result screen 94, e.g., in the order of compressed drawings a1, a2, . . . , a5 as shown in FIG. 15, in step S27. The compressed drawings 96 can quickly be displayed because the amount of data of each of the compressed drawings 96 is small.

The operator can successively scroll through the compressed drawings 96 by continuously pressing the horizontal scroll bar 100 or the vertical scroll bar 102. The scrolling rate can be adjusted as desired by operating a rate setting bar 104.

The vertical scroll bar 102 is used to scroll through the drawing 30 if the drawing 30 is in the form of a bundle of sheets such as circuit drawing sheets or document sheets, as shown in FIG. 11. Specifically, if two or more data are set as the data of the number of original drawing sheets in the drawing retrieval result screen 94 shown in FIG. 13, then the drawing retrieval result screen 98 displays the cover sheet 90 as the compressed drawing 96. If the compressed drawing 96 is the compressed drawing a2 or a4 shown in FIG. 15, then when the vertical scroll bar 102 is operated while it is being displayed, the drawing attribute data Datt except for the drawing title is displayed in a fixed manner, but the drawing title and the compressed drawing 96 are displayed successively in the order of compressed drawings b1, b2, . . . , bn, or compressed drawings c1, c2, . . . , cn in step S27.

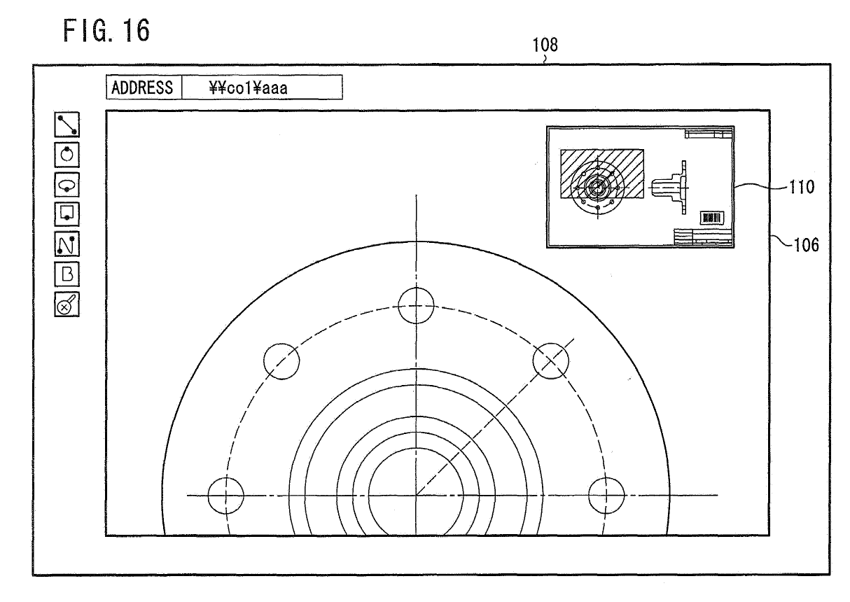

After the desired drawing 30 is retrieved from the successively displayed compressed drawings 96, the operator selects a “DISPLAY CURRENT DRAWING” button in the drawing retrieval result screen 98 in step S28. The selected drawing displaying means 70 requests the drawing information storing unit 16 to send actual drawing image data Dorg relative to the displayed drawing data in step S29. The drawing information storing unit 16 reads the requested actual drawing image data Dorg from the data storage unit 34, and sends the actual drawing image data Dorg to the drawing retrieving unit 20. As shown in FIG. 16, the drawing retrieving unit 20 displays an uncompressed actual drawing 106 according to the actual drawing image data Dorg that have been sent, as a drawing retrieval result screen 108 in step S30.

Since the actual drawing 106 displayed in the drawing retrieval result screen 108 is based on the uncompressed actual drawing image data Dorg that is transferred from the data storage unit 34, it takes a longer period of time to display the actual drawing 106 than the compressed drawing 96. However, since the actual drawing 106 that have been specified is one, the display time does not pose a significant problem. A total display compressed drawing 110 in which a displayed area of the actual drawing 106 is shown hatched in FIG. 16 is also displayed together with the actual drawing 106. The total display compressed drawing 110 allows the operator to easily confirm the position of the displayed area of the actual drawing 106 even if the actual drawing 106 cannot be displayed in its entirety at once on the display monitor.

The operator confirms the displayed actual drawing 106. If the displayed actual drawing 106 is the desired drawing 30, then the operator selects a printing process to output the drawing 30 from the output unit 24B in step S31.

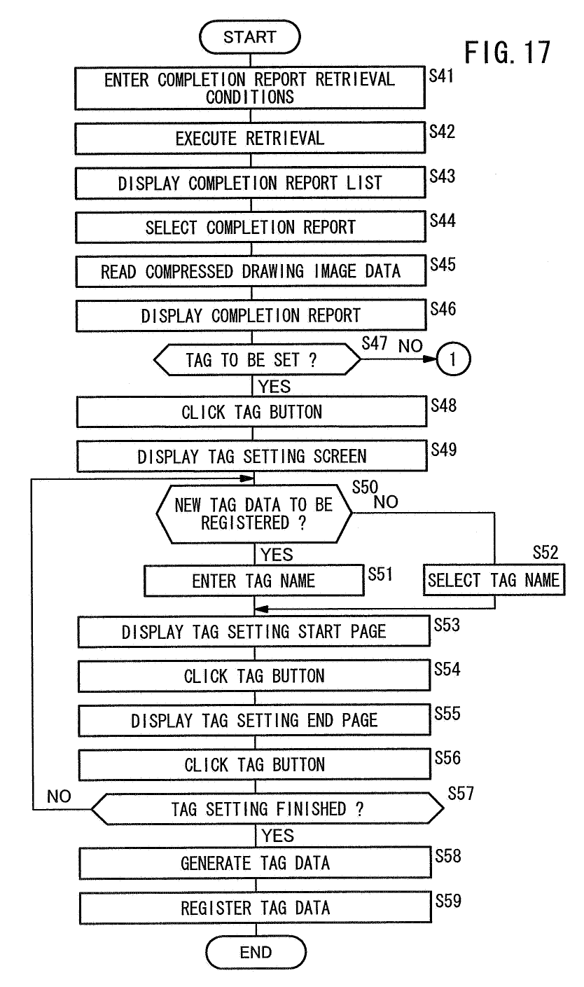

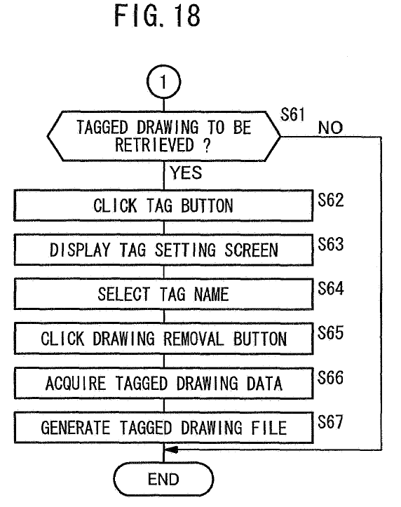

A process of retrieving a completion report and setting tag data in relation to a necessary design drawing or the like or acquiring a design drawing or the like for which tag data has already been set will be described below with reference to flowcharts shown in FIGS. 17 and 18. The completion report represents a file of a data set representative of a series of drawings 30 including a design drawing, an inspection document, a calculation document, an estimation document, etc. about a facility construction, for example.

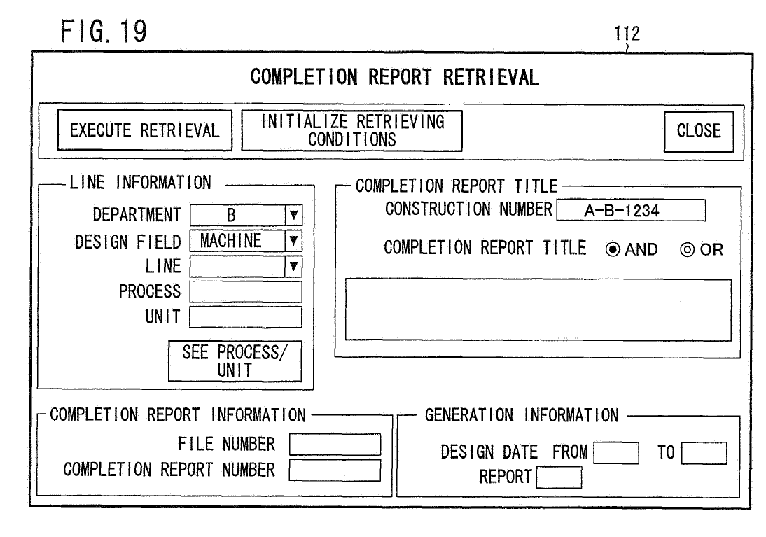

When the operator selects a “RETRIEVE COMPLETION REPORT RETRIEVAL” button for retrieving a completion report in the menu screen 80 shown in FIG. 5, a retrieval condition input screen 112 shown in FIG. 19 is displayed on the display monitor. The operator enters a retrieval condition for a desired completion report in the retrieval condition input screen 112 in step S41. For example, when a drawing 30 is registered, a construction number (see FIG. 8) is set as drawing attribute data Datt. In this manner, drawing attribute data Datt having the same construction number can be retrieved as being related to the same construction.

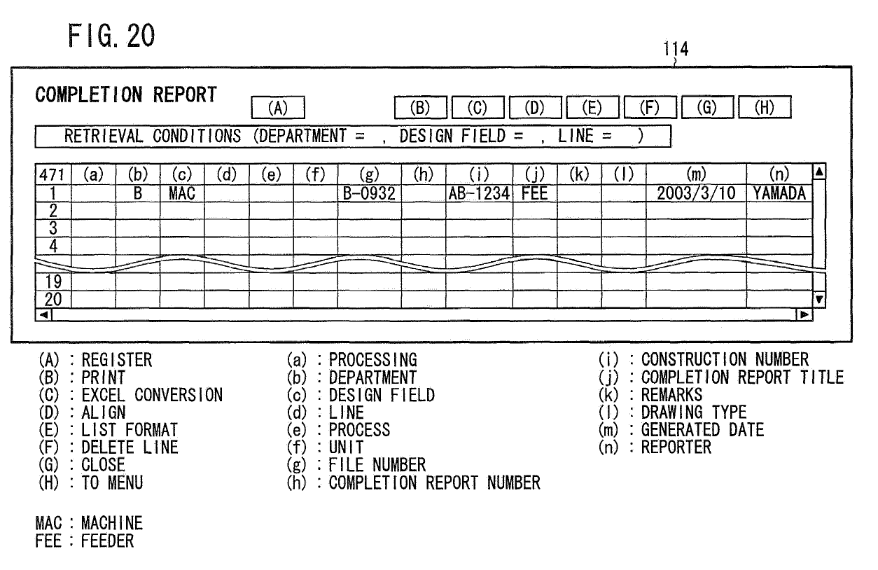

The completion report retrieving means 74 retrieves a completion report having a corresponding construction number, using the drawing attribute data Datt entered in the retrieval condition input screen 112 as a retrieval condition in step S42, and displays a completion report list screen 114 shown in FIG. 20 in step S43.

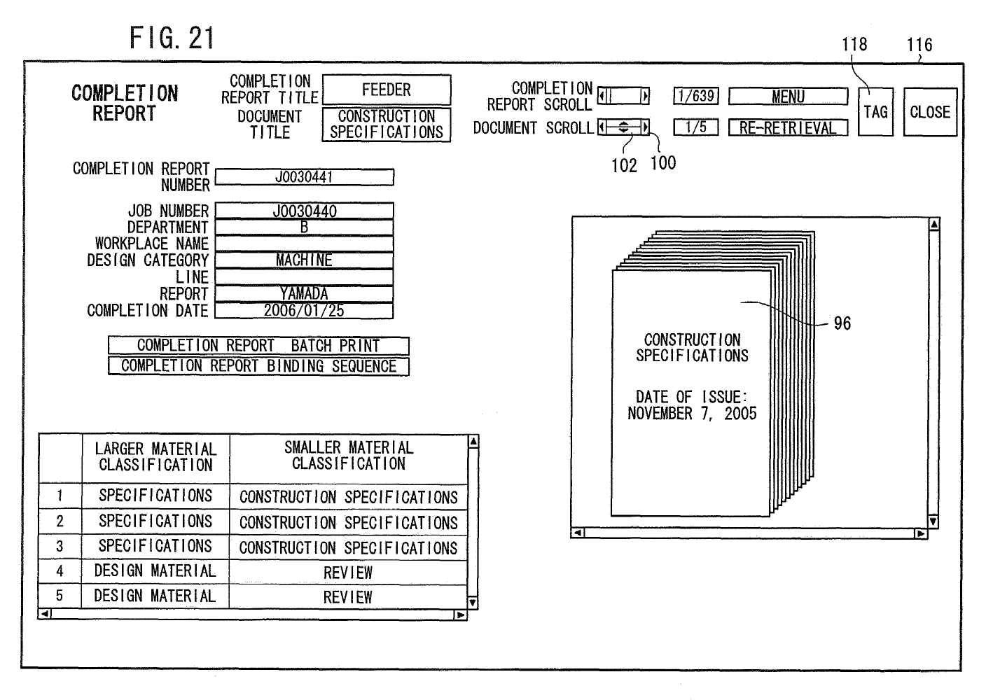

Then, the operator selects a desired completion report based on a completion report title which is a construction title displayed in the completion report list screen 114 in step S44. The completion report retrieving means 74 reads compressed drawing image data Dcom of drawings 30 that make up the selected completion report from the data storage unit 34 in step S45, and displays a completion report display screen 116 shown in FIG. 21 in step S46.

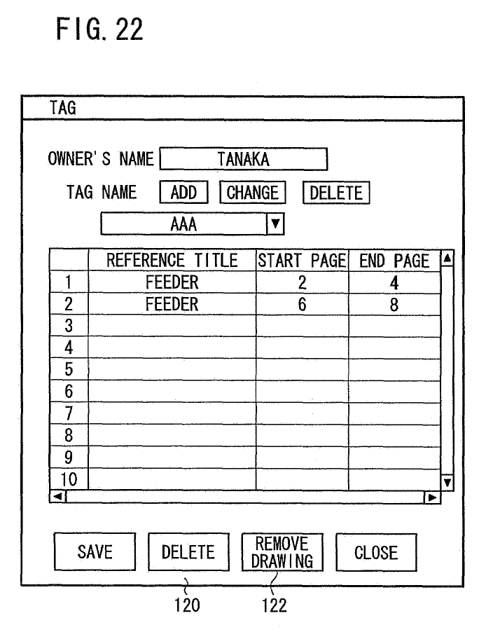

If a desired drawing 30 is selected from the drawings 30 including design drawings and documents such as specifications or the like which make up the designated completion report, and tag data is to be set for the selected desired drawing 30 in step S47, then the operator clicks a “TAG” button 118 displayed in the completion report display screen 116 shown in FIG. 21 in step S48. When the “TAG” button 118 is clicked, a tag setting screen 120 shown in FIG. 22 is displayed in the completion report display screen 116 in step S49.

After the operator enters the name of the owner of tag data in the displayed tag setting screen 120, if the operator is to newly set tag data in step S50, then the operator enters a tag name in step S51. In the example shown in FIG. 22, “AAA” is entered as a tag name, and the title of the completion report is displayed as a material title for which the tag data is to be set. If new tag data is to be added to already registered tag data or already registered tag data is to be changed in step S50, then the operator selects the tag name in step S52.

After the tag name is set or selected, the operator presses the horizontal scroll bar 100 and the vertical scroll bar 102 in the same manner as with the drawing retrieving process performed by the drawing retrieving function, thereby scrolling through the compressed drawings 96 displayed in the completion report display screen 116 until a compressed drawing 96 of a start page for which the tag data is to be set, is displayed in step S53. While the compressed drawing 96 of the desired start page is being displayed, the operator clicks the “TAG” button 118 of the drawing selecting means 52 in step S54 to enter the page of the displayed compressed drawing 96 into a start page column in the tag setting screen 120. Then, the operator scrolls the completion report display screen 116 again until a compressed drawing 96 of an end page for which the tag data is to be set, is displayed in step S55. Thereafter, the operator clicks the “TAG” button 118 in step S56 to enter the page of the displayed compressed drawing 96 into an end page column on the tag setting screen 120.

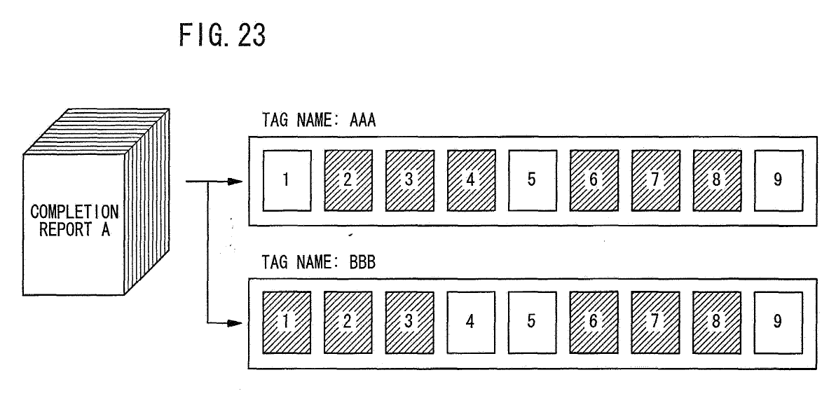

Since the compressed drawings 96 whose amounts of data are small are displayed in the completion report display screen 116, the compressed drawings 96 can be scrolled at a high speed. Simply by selecting a compressed drawing 96 as a start page and a compressed drawing 96 as an end page, compressed drawings 96 in a desired page range from the start page to the end page can efficiently be selected as drawings for which tag data is to be set. For example, as shown in FIG. 23, compressed drawings 96 between a start page 2 and an end page 4 entered into the tag setting screen 120, and compressed drawings 96 between a start page 6 and an end page 8 entered into the tag setting screen 120 can be selected as drawings for which tag data is to be set. If one drawing is selected as both a start page and an end page, then only a single compressed drawing 96 is selected as a drawing for which tag data is to be set.

After drawings are selected by repeating the above process in step S57, the tag data setting means 53 generates tag data associated with tag names using as pointers, addresses and file names in the data storage unit 34 of the compressed drawings 96 in the page range designated by the start page and the end page in step S58, and registers the generated tag data in the tag data storing means 55 in step S59.

Since the tag data is not directly set in compressed drawing image data Dcom or actual drawing image data Dorg with respect to the compressed drawings 96, but is independently set as data specifying the compressed drawings 96, it is possible to generate a plurality of tag groups of tag data associated with different tag names AAA, BBB for the same completion report A, as shown in FIG. 23. Each of the tag groups can simultaneously be set by different operators.

If a desired drawing 30 is to be retrieved using already registered tag data in step S61, then the operator clicks the “TAG” button 118 displayed in the completion report display screen 116 in step S62 to display the tag setting screen 120 in step S63. The operator then selects a desired tag name in step S64. At this time, the operator can narrow down tag names by entering the owner name into the tag setting screen 120. Then, when the operator clicks a “REMOVE DRAWING” button 122 in step S65, the tagged drawing acquiring means 54 reads a plurality of actual drawing image data Dorg designated by the tag data, from the data storage unit 34 in step S66, and couples the these actual drawing image data Dorg to generate a tagged drawing file in step S67. The generated tagged drawing file is stored in the tagged drawing storing means 56, and can be output from the output unit 24B, when necessary.

In the above embodiment, a completion report is selected, a desired compressed drawing 96 is selected from compressed drawings 96 that make up the selected completion report, and tag data is set for the selected compressed drawing 96. However, tag data may be set for a compressed drawing 96 that has been retrieved using the drawing retrieval result screen 98 shown in FIG. 14, for example.

Although certain preferred embodiments of the present invention have been shown and described in detail, it should be understood that various changes and modifications may be made therein without departing from the scope of the appended claims.

What is claimed is:

1. A system for managing image data, comprising:
image data storing means for storing a plurality of pages of drawings or documents as image data;
image data selecting means for selecting image data in a desired range of pages from said image data stored by said image data storing means;
tag data setting means for setting tag data in relation to said image data selected by said image data selecting means;
tag data storing means for storing said tag data; and
image data acquiring means for acquiring said image data specified by said tag data from said image data storing means.

2. A system according to claim 1, wherein said tag data setting means sets said tag data in relation to said image data in said range of pages which is determined by said image data in a start page selected by said image data selecting means and said image data in an end page selected by said image data selecting means.

3. A system according to claim 1, wherein said tag data setting means is capable of setting a plurality of tag groups of said tag data set in relation to said image data in said range of pages.

4. A system according to claim 1, wherein said tag data setting means sets a tag name for said tag data, and said image data acquiring means acquires said image data from said image data storing means based on said tag name.

5. A system according to claim 1, further comprising tagged image data storing means for storing said image data acquired according to said tag data as a single file.

6. A system according to claim 1, wherein said image data storing means stores said image data as compressed image data, and said image data selecting means selects said image data in the desired range of pages from said compressed image data.

7. A method of managing image data, comprising the steps of:
selecting image data in a desired range of pages from stored image data representing a plurality of pages of drawings or documents;
setting tag data in relation to said range of pages; and
storing said tag data;
wherein desired image data is acquired based on the stored tag data.

8. A method according to claim 7, wherein said range of pages is set by a selected start page and a selected end page.

9. A method according to claim 7, wherein said tag data is capable of being set as a plurality of tag groups.

10. A method according to claim 7, wherein an identifiable tag name is set for said tag data.
